(19) United States
(12) Patent Application Publication
(10) Pub. No.: US 2018/0012477 A1
(43) Pub. Date: Jan. 11, 2018

(54) PET DOOR GAURD

(71) Applicant: Charlotte Angela Lewis, North Stonington, CT (US)

(72) Inventor: Charlotte Angela Lewis, North Stonington, CT (US)

(21) Appl. No.: 15/642,924

(22) Filed: Jul. 6, 2017

Related U.S. Application Data
(60) Provisional application No. 62/358,716, filed on Jul. 6, 2016.

(51) Int. Cl. G08B 21/18; E06B 7/28; A01K 1/035

(52) U.S. Cl. CPC G08B 21/18; A01K 1/035; E06B 7/28

(57) ABSTRACT

A door guard. The door guard includes a plate attached to a door. A sensor is operable to detect when a pet scratches the plate with their nails. The sensor transmits a signal to a speaker via a transmitter and a receiver when the sensor detects the scratching. A prerecorded sound is played from the speaker, thereby notifying the pet owner that the pet needs to go outside.

### CROSS-REFERENCE TO RELATED APPLICATION

This application claims the benefit of priority of U.S. provisional application No. 62/358,716, filed Jul. 6, 2016, the contents of which are herein incorporated by reference.

### BACKGROUND OF THE INVENTION

The present invention relates to a pet door guard and, more particularly, to a pet door guard that notifies the owner when scratched.

Many dog owners let their dogs in and out of their house via an exterior door. A dog will communicate its desire to pass through the door by whining, whimpering, barking, and/or scratching on the door. Some dogs prefer scratching on the door and/or door jam to communicate their desire to pass through the closed door.

Most undesirably, scratching on the door, door jam, or an adjacent wall will cause damage. Regardless of whether the door is fabricated from wood, metal, or even some other material, the scratching of a dog will, in time, mar or otherwise damage the surface of the door.

In an effort to avoid damage caused by pet scratching on and around a door, owners of pets commonly install decorative smooth metal plates over the locations on and around the door where the pet tends to scratch. Unfortunately, since scratching on the metal plate does not produce any sound, a dog will often continue to scratch the door at some other location. Thus, the scratching and its accompanying marring and damage continue at other locations.

As can be seen, there is a need for a pet door guard that properly alerts a pet owner.

### SUMMARY OF THE INVENTION

In one aspect of the present invention, a door guard comprises: a plate configured to secure to a door and comprising a front surface and a rear surface; a sensor operable to detect when a pet scratches the plate, the sensor comprising a transmitter; and a speaker comprising a receiver, wherein when the sensor detects the pet scratching the plate, a signal is sent from the transmitter to the receiver and the speaker plays a prerecorded sound.

In another aspect of the present invention, a method of detecting a pet comprises: securing a plate to a door, wherein the plate comprises a front surface, a rear surface and a sensor; and operatively connecting a speaker to the sensor, wherein when a pet scratches the plate, the sensor detects the pet scratching and sends a signal to the speaker to play a prerecorded sound.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a front perspective view of an embodiment of the present invention;

FIG. 3 is a rear perspective view of an embodiment of the present invention; and

FIG. 4 is a section detail view taken along line 4-4 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

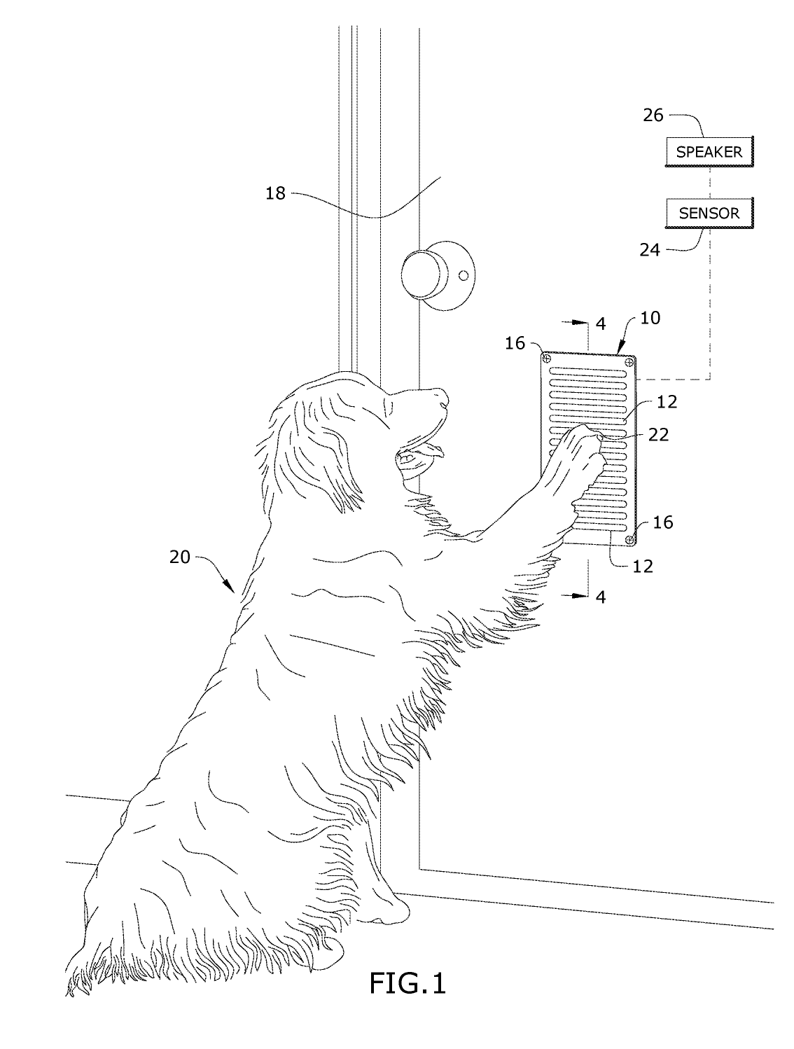

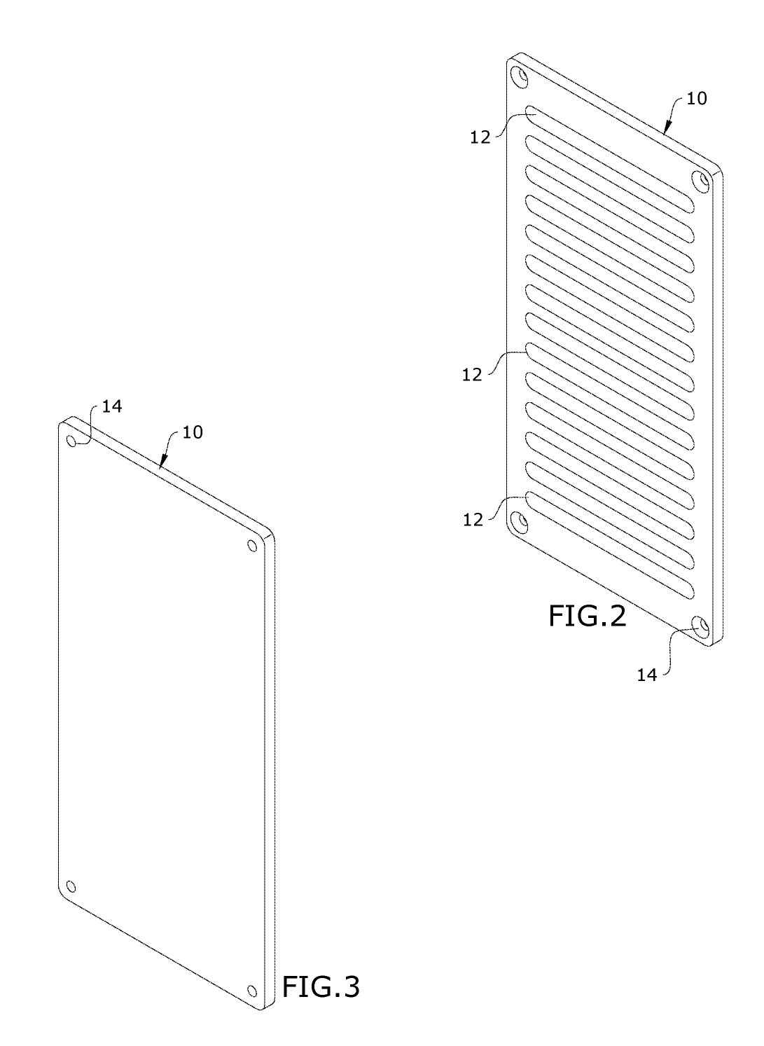

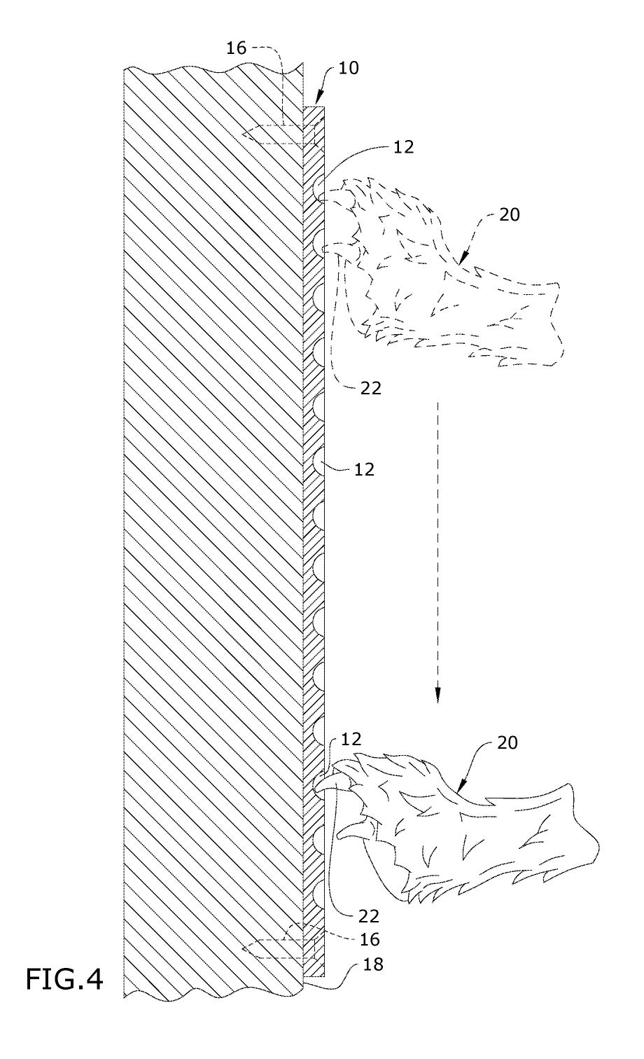

Referring to FIGS. 1 through 4, the present invention includes a door guard. The door guard includes a plate 10 attached to a door 18. A sensor 24 is operable to detect when a pet 20 scratches the plate 10 with their nails 22. The sensor 24 transmits a signal to a speaker 26 via a transmitter and a receiver when the sensor 24 detects the scratching. A prerecorded sound is played from the speaker 26, thereby notifying the pet owner that the pet 20 needs to go outside.

The plate 10 of the present invention may include a metal plate having a front surface and a rear surface. The plate 10 may include a substantially flat front surface and a rear surface with a rectangular edge. The plate 10 may include other shapes, such as circular, square, triangular and the like.

The plate 10 is typically fastened to the door 18 below the door knob in reach of the pet 20. The plate 10 may be fastened to the door 18 by fasteners 16. For example, the plate 10 may include fastener openings 14. The fasteners 16 may be driven through the openings 14 and into the door 18, securing the plate 10 to the door 18. Alternatively, the plate 10 may be secured to the door 18 by strong adhesives or other fastening means.

In certain embodiments, the front surface of the plate 10 includes a plurality of indentations 12. The plurality of indentations 12 may be elongated and disposed vertically relative to one another. The indentations 12 may produce a sound when scratched, thereby notifying the pet owner that the pet 20 needs to go outside.

The sensor 24 may be coupled to the plate 10 or may be disposed adjacent to the plate 10. The sensor 24 may include at least one of a vibration sensor, a pressure sensor and a motion sensor. The vibration sensor may detect when the plate 10 vibrates beyond a certain threshold. The pressure sensor may detect when a pressure is applied to the plate 10 beyond a certain threshold. The motion sensor may detect motion within the indentations 12 or within a close proximity of the plate 10.

The speaker 26 of the present invention may be remote from the plate 10 and thereby remote from the sensor 24. In such embodiments, the sensor 24 includes a wireless transmitter and the speaker includes a wireless receiver. The speaker 26 may be standalone. Alternatively, the speaker may be part of a smart device, such as a tablet or smart phone. In such embodiments, the sensor 24 transmits the signal to the smart device and the smart device plays a sound, thereby notifying the pet owner. In such embodiments, the smart device may include an application loaded on a memory. A processor of the smart device receives the signal and automatically launches the application, which may then play the prerecorded sound from the speaker.

The present invention may further include a method of notifying a pet owner. The method may include the following steps: securing the plate described above to a door; operatively connecting the speaker described above to the sensor described above, wherein when a pet scratches the plate, the sensor detects the pet scratching and sends a signal to the speaker to play a prerecorded sound.

It should be understood, of course, that the foregoing relates to exemplary embodiments of the invention and that modifications may be made without departing from the spirit and scope of the invention as set forth in the following claims.

What is claimed is:

1. A door guard comprising:
a plate configured to secure to a door and comprising a front surface and a rear surface;
a sensor operable to detect when a pet scratches the plate, the sensor comprising a transmitter; and
a speaker comprising a receiver, wherein
when the sensor detects the pet scratching the plate, a signal is sent from the transmitter to the receiver and the speaker plays a prerecorded sound.

2. The door guard of claim 1, wherein the speaker is remote from the plate, wherein the transmitter is a wireless transmitter and the receiver is a wireless receiver.

3. The door guard of claim 1, wherein the sensor is at least one of a vibration sensor, a pressure sensor and a motion sensor.

4. The door guard of claim 1, wherein the sensor is a vibration sensor.

5. The door guard of claim 1, wherein the plate comprises a plurality of openings sized to receive fasteners therethrough.

6. The door guard of claim 1, wherein the front surface comprises a plurality of indentations.

7. The door guard of claim 6, wherein the plurality of indentations are elongated and disposed vertically relative to one another.

8. A method of detecting a pet comprising:
securing a plate to a door, wherein the plate comprises a front surface, a rear surface and a sensor; and
operatively connecting a speaker to the sensor, wherein
when a pet scratches the plate, the sensor detects the pet scratching and sends a signal to the speaker to play a prerecorded sound.

9. The method of claim 8, wherein the sensor comprises a wireless transmitter and the speaker comprises a wireless receiver, wherein the speaker is remote from the plate.

10. The method of claim 8, wherein the front surface comprises a plurality of indentations, wherein the plurality of indentations are elongated and disposed vertically relative to one another.

11. The method of claim 8, wherein the step of securing a plate to a door comprises driving fasteners through openings of the plate and into the door.

12. The method of claim 8, wherein the sensor is a vibration sensor.
